(19) United States
(12) Patent Application Publication
(10) Pub. No.: US 2005/0016368 A1
(43) Pub. Date: Jan. 27, 2005

(54) Method and system for generating musical variations directed to particular skill levels

(76) Inventor: James C. Perla, San Francisco, CA (US)

Correspondence Address: Olympic Patent Works PLLC;Robert W. Bergstrom, P.O. Box 4277, Seattle, WA, 98194-0277, US

(21) Appl. No.: 10/858,821

(22) Filed: Jun. 1, 2004

Related U.S. Application Data
(60) Provisional application No. 60/475,214, filed on May 30, 2003.
(60) Provisional application No. 60/548,927, filed on Mar. 1, 2004.

(51) Int. Cl. G09B 15/00; H02M 5/00; G10H 7/00; G10H 3/00

(52) U.S. Cl. 84/723

(57) ABSTRACT

Various embodiments of the present invention are directed to an automated method and system component for generating variations of one or more musical selections directed to particular students or to particular skill levels into which students may be classified. The method and system component may be included in a wide variety of different music rendering, music display, and music instruction systems. In one embodiment of the present invention, variations are generated by filtering each layer of a musical selection with respect to a number of common, musical components, with the filtering chosen to reflect a selected or desired skill level. In the embodiment of the present invention, the layers of a musical selection include a melody line, a chord progression, and a bass line, and musical components include key signature, rhythm, pitch range, tempo and meter, and technique. Skill level may be based on a numerically-encoded range of skill levels, or may include a number of fixed skill levels, such as beginning, easy, intermediate, and advanced levels.

### CROSS-REFERENCE TO RELATED APPLICATION

This application claims the benefit of provisional application No. 60/475,214, filed May 30, 2003 and 60/548,927, filed Mar. 1, 2004.

### TECHNICAL FIELD

The present invention is related to automated musical training and interactive display systems and, in particular, to musical training and interactive display systems that generate variations of musical selections with varying levels of difficulty.

### BACKGROUND OF THE INVENTION

For hundreds of years, musical instructors and musical-instruction-book authors have manually prepared altered versions of musical selections to facilitate instruction of students with varying levels of skill and musical competence and for arranging musical selections for different types and numbers of musical instruments. By altering musical selections, music teachers and authors of musical instruction books can tailor well known and musically pleasing pieces to various skill levels of different classes of students, as well as to skill levels to which the music teachers and authors of musical instruction books are attempting to elevate a particular class of students. Variations of musical selections featuring a range of complexity levels provide a useful vehicle for musical instruction that allows a student to experience the pleasure of performing musical pieces without also frustrating the student by demanding greater skill or musical competence than the student can be expected to display at a particular point in time.

Until now, the generation of variations of musical selections with ranges of difficulties for performance have been largely a tedious, manual, and imperfect process. In general, an instructor or musical-instruction-book author can provide, at best, one or only a few variations of a particular musical selection, and the granularity of skill level addressed by the variations is thus rather large. A musical student is therefore constrained to selecting music from among an often narrow selection of musical pieces at any particular desired skill level. Musical teachers, authors of musical-instruction-books, and other musical professionals have recognized the need for a means to generate a range of variations directed to a corresponding range of skill levels for a large number of different musical pieces that is relatively inexpensive and efficient in time, and that provides an ability to customize, or tailor, variation generation as closely as possible to an individual student or to a particular skill level.

### SUMMARY OF THE INVENTION

Various embodiments of the present invention are directed to an automated method and system component for generating variations of one or more musical selections directed to particular students or to particular skill levels into which students may be classified. The method and system component may be included in a wide variety of different music rendering, music display, and music instruction systems. In one embodiment of the present invention, variations are generated by filtering each layer of a musical selection with respect to a number of common, musical components, with the filtering chosen to reflect a selected or desired skill level. In the embodiment of the present invention, the layers of a musical selection include a melody line, a chord progression, and a bass line, and musical components include key signature, rhythm, pitch range, tempo and meter, and technique. Skill level may be based on a numerically-encoded range of skill levels, or may include a number of fixed skill levels, such as beginning, easy, intermediate, and advanced levels.

### BRIEF DESCRIPTION OF THE DRAWINGS

FIG. 1 illustrates a typical musical system in which the method and system component of various embodiments of the present invention may be included.

FIG. 2 is a high-level selection screen displayed by the musical system shown in FIG. 1.

FIG. 3 shows a second-level display window that, in the hypothetical musical system illustrated in FIGS. 1 and 2, allows a user to select parameters that specify a variation of a musical piece directed to a particular skill level.

FIG. 4 is a high-level control-flow diagram for the routine “variation generation”, which generates a variation of a musical selection according to skill-selection parameters input by a user.

FIG. 5 shows the key signature for the key G.

FIG. 6 shows a table listing the major-key-signature and minor-key-signature sets for each skill level, with skill levels increasing in complexity, or difficulty, numerically from skill level 0 to skill level 4.

FIG. 7 shows an ordering of the key signatures in a circle of key signatures.

FIG. 8 shows a circle-of-fifths representation of the key signatures.

FIG. 9 is a control-flow diagram for the routine “key signature filter” by which key-signature filtering is carried out in one embodiment of the present invention.

FIG. 10 shows a table of rhythm filters used to alter the musical layers of a musical selection with respect to the rhythm component.

FIG. 11 shows several tables that specify hand and finger position filtering carried out as part of technique filtering.

### DETAILED DESCRIPTION OF THE INVENTION

Embodiments of the present invention are directed to a method and system component for automated generation of variations of musical selections with varying levels of difficulty, or, in other words, directed to various different levels of performance skill. Although the present invention is described, below, with respect to a small number of embodiments, there are many possible different variations of the present invention. A detailed set of specifications for several embodiments of the present invention are included in Appendix A.

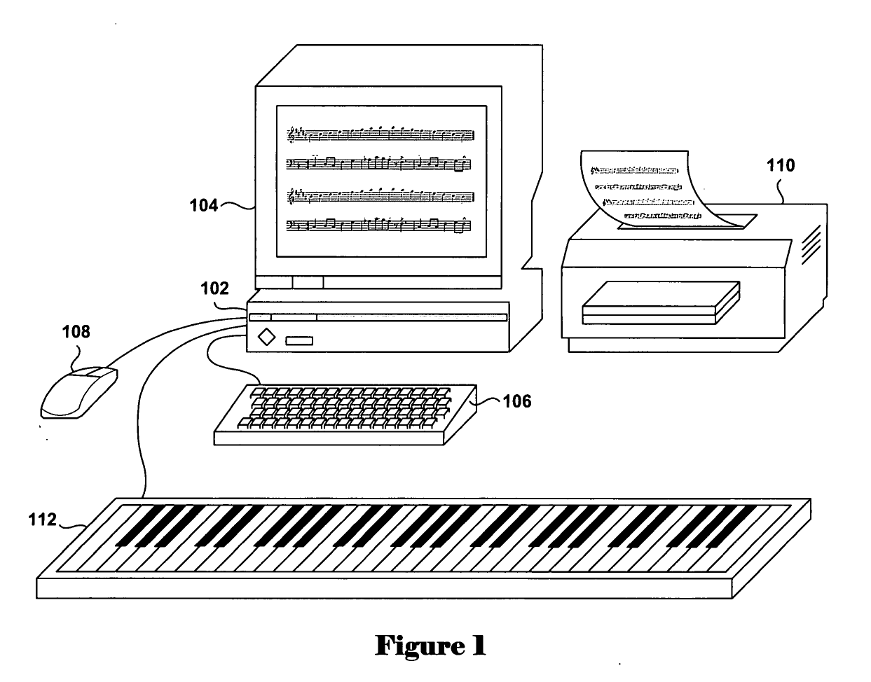

FIG. 1 illustrates a typical musical system in which the method and system component of various embodiments of the present invention may be included. As shown on FIG. 1, a representative musical system may include a personal computer (“PC”) 102 with a display device 104, standard input devices, such as a keyboard 106 and mouse 108, an attached printer 110, and one or more musical input devices, such as a keyboard 112 or electric guitar. The musical system can be used for musical composition, musical transposition, interactive display of music while performing or practicing, and for interactive instruction. For example, a user may arrange for the system to display portions of a musical selection while the user performs the musical selection on an attached musical input device, with the display automatically scrolled at a rate selected by the user, and with metronome beats output by the system at correct time intervals. As another example, the user may compose music using the standard input devices, with the composed music displayed interactively to the user on a display device 104 and printable by the user on the attached printer 110.

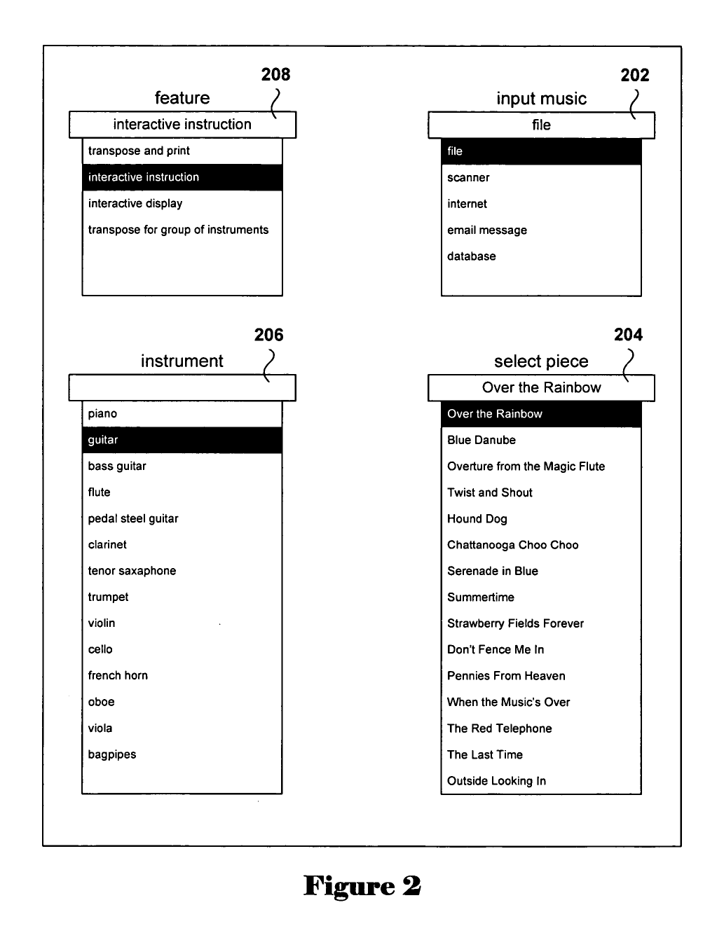

FIG. 2 is a high-level selection screen displayed by the musical system shown in FIG. 1. The high-level selection screen, shown on FIG. 2, is an example selection screen that allows a user to specify operation of the musical system. In the example selection screen shown on FIG. 2, a user may select an input method for inputting a musical selection via a first selection window 202, select a specific musical piece in a second selection window 204, select an instrument or musical-input device in a third selection window 206, and select a system feature to invoke using a fourth selection window 208. Selection of any of the displayed options may, in turn, result in display of more detailed selection windows specific to the particular option selected. In the system illustrated in FIGS. 1 and 2, a user may choose to input music from a digital file, a database of music already inputted into the system, by scanning and digitizing sheet music, selecting the music from the internet, or from an email message. Many other possible types of input music may be added to this option list, depending on the type of user to which the musical system is directed. In the system described with respect to FIGS. 1 and 2, a user may choose to use the system for interactive instruction, much as an automated music teacher, interactively display musical selections for practice or performance, or transpose a musical selection to different parts for each of a group of instruments or to different key signatures.

As discussed above, it would be desirable, in many different situations, including during operation of the hypothetical musical system illustrated in FIGS. 1 and 2, to be able to generate one or more variations of a musical selection directed to an individual user's skill level or to particular skill levels in which users can be generally classified. For example, when the system is used for interactive display of a musical selection, to allow a user at a particular skill level to perform the displayed music, it would be desirable for the user to be able to select, generate, and display a variation of a musical selection suitable for the user's skill level. As an another example, it would be desirable for the user to be able to automatically generate a skill-level-directed variation of the musical selection for printing, including skill-level-directed variations for each part played by a group of musicians on different instruments.

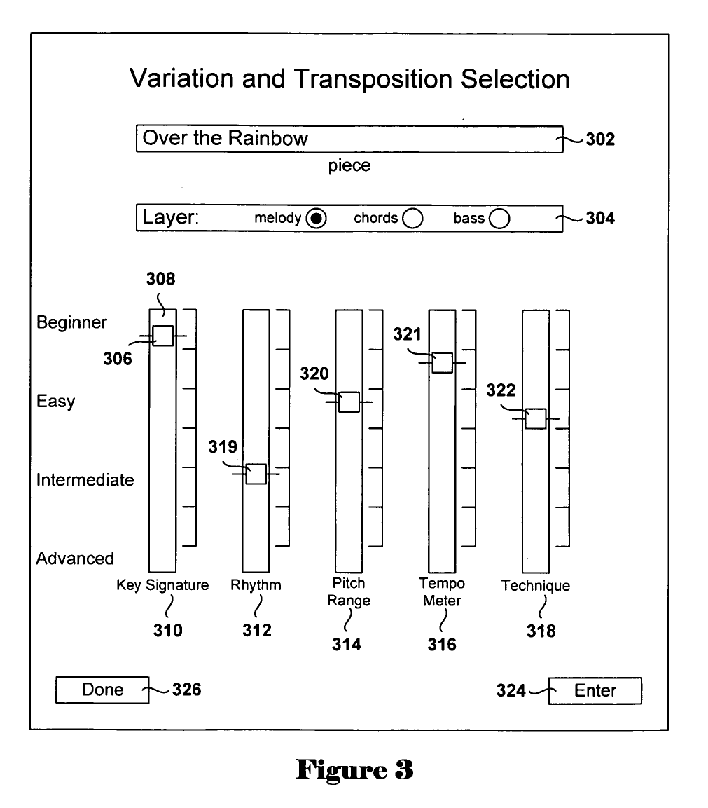

One embodiment of the present invention provides a method and system component to enhance a musical system, such as the hypothetical music system shown on FIGS. 1 and 2, to automatically generate skill-level-directed variations of selected pieces. In the hypothetical musical system, for example, once a user makes high-level selections that define subsequent operation of the musical system, a second-level selection window may be displayed to provide the user with the ability to generate a variation of a musical selection tailored to a desired skill level for subsequent use in the instruction, display, or printing operation. FIG. 3 shows a second-level display window that, in the hypothetical musical system illustrated in FIGS. 1 and 2, allows a user to select parameters that specify a variation of a musical piece directed to a particular skill level.

The second high-level display window includes a text-display window 302 that displays the title of the musical selection. The second-level display window includes a layer-selection window 304 that allows the user to select one of a number of different layers of the musical selection. In the described embodiment, the layers include (1) the melody line; (2) the chord progression; and (3) the bass line. When the user selects a particular musical layer, using the layer-selection window 304, the musical system displays the skill-level, with respect to various different components of the musical selection, to which a variation of the selected musical layer should be generated. In the hypothetical display window shown in FIG. 3, the skill-level is shown as the position of a skill-selection slider button, such as skill-selection slider button 306, that can be moved vertically within a skill-selection-range window, such as skill-selection-range window 308. Initially, the skill-selection slider buttons may display default skill-level values for each component. In the described embodiment, the set of musical components with respect to which skill levels can be selected by the user includes: (1) the key signature 310; (2) rhythm 312; (3) pitch range 314; (4) tempo and meter 316, and (5) technique 318. When a user has adjusted the skill-level selections for each of the components for a particular layer, using the layer-selection window 304 and the skill-selection slider buttons 306 and 319-322, the user may input a mouse click to an enter button 324 to record the skill-level selections for the selected layer. Once the user is satisfied with the skill-level selections for all layers, the user can input a mouse click to a completion button 326, which collects and stores the skill-level selections and invokes a variation-generation routine to generate a variation of the indicated musical selection according to the user's skill-level selections.

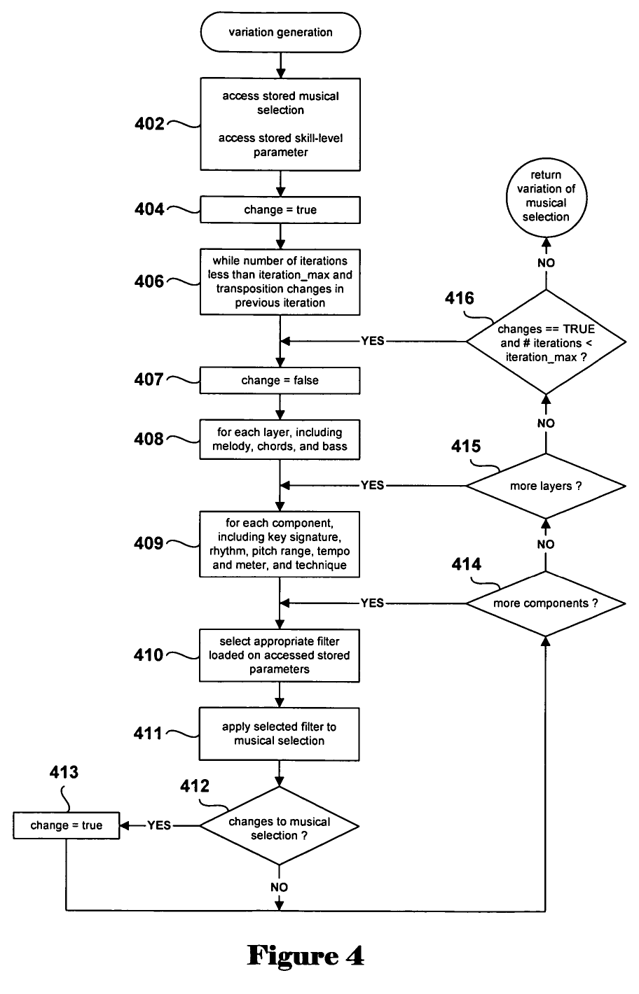

FIG. 4 is a high-level control-flow diagram for the routine “variation generation,” which generates a variation of a musical selection according to skill-selection parameters input by a user. In step 402, the routine “variation generation” accesses a stored musical selection and accesses stored skill-level parameters that specify the variation to be generated from the stored musical selection. A musical selection may be stored in many different possible computer-readable music encodings. The skill-level parameters may be numerical encodings of the skill levels chosen with respect to each musical component of each musical layer, such as the parameters selectable via the hypothetical display window shown on FIG. 3, although many other encodings of the parameters values are also possible Next, in step 404, the variable “change” is set to the Boolean value TRUE. Then, in the while-loop of steps 406-416, the routine “variation generation” iteratively generates a variation of the musical selection corresponding to the selection parameters accessed in step 402. As a first step in the while-loop, the variable “change” is set to FALSE, in step 407. Next, in the nested for-loops of step 408-415, a next iteration of variation generation is carried out. If, in this next iteration, any changes are made to the current state of the musical selection, as determined in step 412, then the variable “changes” is set to TRUE, in step 413, so that another iteration of the while-loop of step 406-416 is carried out. In the described embodiment of the routine “variation generation,” execution of the while-loop of steps 406-416 may also be terminated when the number of iterations already executed is equal to a constant “iteration_max.”

The outer for-loop of steps 408-415 considers, in each iteration, each musical layer of the musical selection, including the melody line, chord progression, and bass line in the described embodiment. The melody line corresponds to a dominant motif, generally in the treble-clef lines in standard musical notation. The chord progression is generally a collection of chords, encoded by multiple note-indicating ovals adjoined via a common note stem, in the treble-clef lines and/or bass-clef lines of standard musical notation. The bass line is normally found in the bass-clef lines in standard music notation. Thus, each of the layers separately treated in the described embodiment correspond directly to easily-identified sets of notes, rests, tempo indications, and fingering positions in standard musical notation. In each iteration of the inner for-loop of steps 409-414, each musical component is separately considered. In step 410, an appropriate filter or filters based on the user-specified and stored skill-level parameters is chosen for the component, and in step 411, the selected filter or filters is applied to the current state of the musical selection in order to translate the musical selection with respect to the currently considered musical component and currently considered musical layer to correspond to the user-specified and stored skill-level parameters. If application of the filter or filters, in step 411, results in additional changes to the musical selection, as detected in step 412, then the variable “changes” is set to TRUE in step 414. Conditional steps 414-416 control whether or not additional iterations of the next for-loops and encompassing while-loop are carried out. Thus, the routine “generation variation” iteratively applies filters to a musical selection until either no further changes are made to the selection or until a maximum number of iterations are executed, so that the resulting variations of the musical selection corresponds to selected and stored skill-level parameters. An iterative approach allows the musical selection to be independently modified with respect to each layer and component, while enforcing the overall constraint represented by skill-level parameters specified for multiple layers and components.

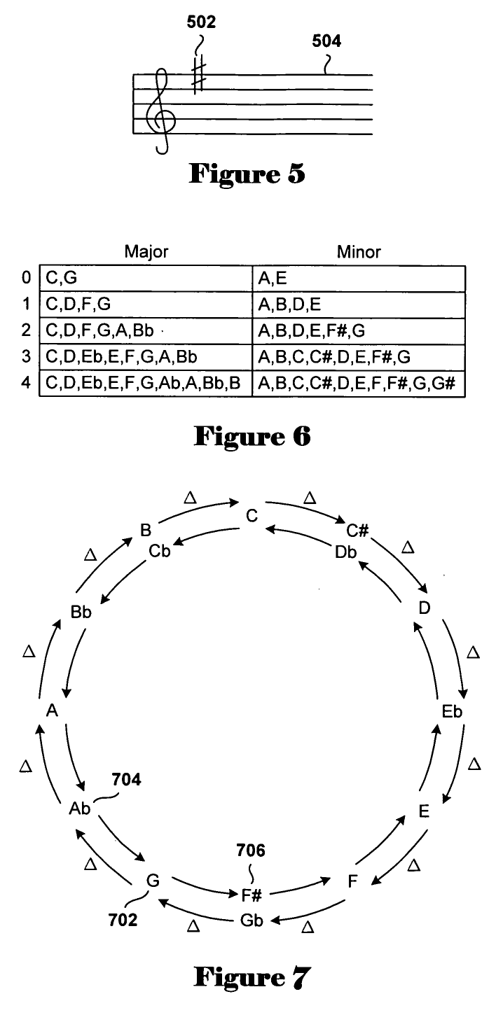

Key-signature filtering may involve transposing a selected piece of music from an original key signature to a new, simpler key signature. A selected musical piece is associated with an original key signature. The key signature is determined by the number and positions of sharp signs “#” and flat signs “♭” placed onto lines and spaces that designate musical notes, following a clef sign at the beginning of the musical notation for a selected piece of music. The sharp and flat signs indicate half-step pitch changes associated with each base note to be used while performing with a piece of music. For example, FIG. 5 shows the key signature for the key G. The sharp sign 502 on the line 504 of the musical staff representing the note F indicates that F should be played as F#. A piece of music can be changed, by transposition, from one key signature to another key signature by raising or lowering each note in a musical selection by a fixed number of pitch half-steps. For example, raising each note by one-half step changes the key signature from G to Ab, eliminating the sharp sign of the F sharp key signature shown on FIG. 5 and introducing four flat signs. In general, it is easier for a student to perform music in key signatures with as few sharp or flat signs as possible. Each flat or sharp sign requires the student to remember to shift notes on which the sharp sign or flat sign is placed by one-half step. When no sharp signs or flat signs occur in the key signature, such as in the key of C, the student has no half-step adjustments to remember while performing the music.

In one embodiment of the present invention, five different sets of key signatures corresponding to five different skill levels are employed. FIG. 6 shows a table listing the major-key-signature and minor-key-signature sets for each skill level, with skill levels increasing in complexity, or difficulty, numerically from skill level 0 to skill level 4. FIG. 7 shows an ordering of the key signatures in a circle of key signatures. Each key signature is separated from an adjacent key signature by one-half step in pitch, represented by the symbol “Δ”. Thus, for example, raising the notes of the key signature G 702 by 1Δ results in key signature Ab 704, while lowering the pitch of each note in a musical selection with key signature G by 1Δ results in key signature F# 706.

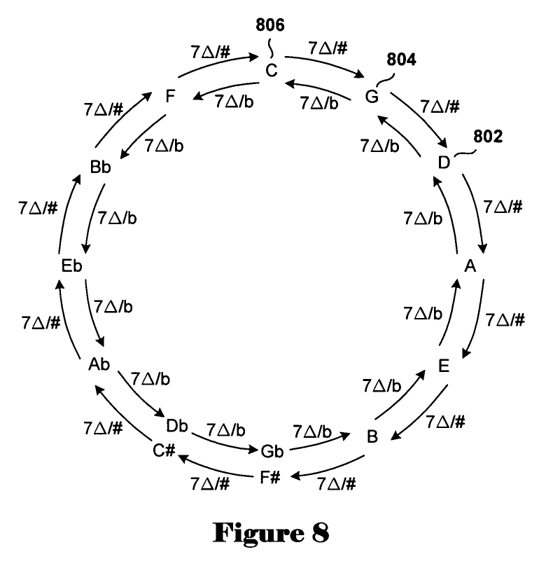

The key signatures can also be placed into a circle-of-fifths representation. FIG. 8 shows a circle-of-fifths representation of the key signatures. In the circle-of-fifths representation, each key is separated from adjacent keys by 7Δ. Thus, for example, the key D 802 is separated from the key G 804 by 7Δ in the sharp direction, while the key C 806 is separated from the key G 804 by 7Δ in the flat direction. For major keys, a key signature may be characterized as flat or sharp depending on the relative position of the key in the circle-of-fifths representation from the key C 806. For minor keys, a key signature may be designated as sharp or flat depending on the relative position of the key in the circle-of-fifths representation of the key signatures. In general, when a key is closer to the reference key in the flat, or counterclockwise direction, the key is considered to be flat, while if the key is closer to the reference key in the sharp, or clockwise direction, the key is considered to be sharp. The reference keys are considered neither flat nor sharp. Thus, a key signature may be sharp, flat, or neither sharp nor flat, depending on its proximity to a reference key in the circle-of-fifths representation of the key signature.

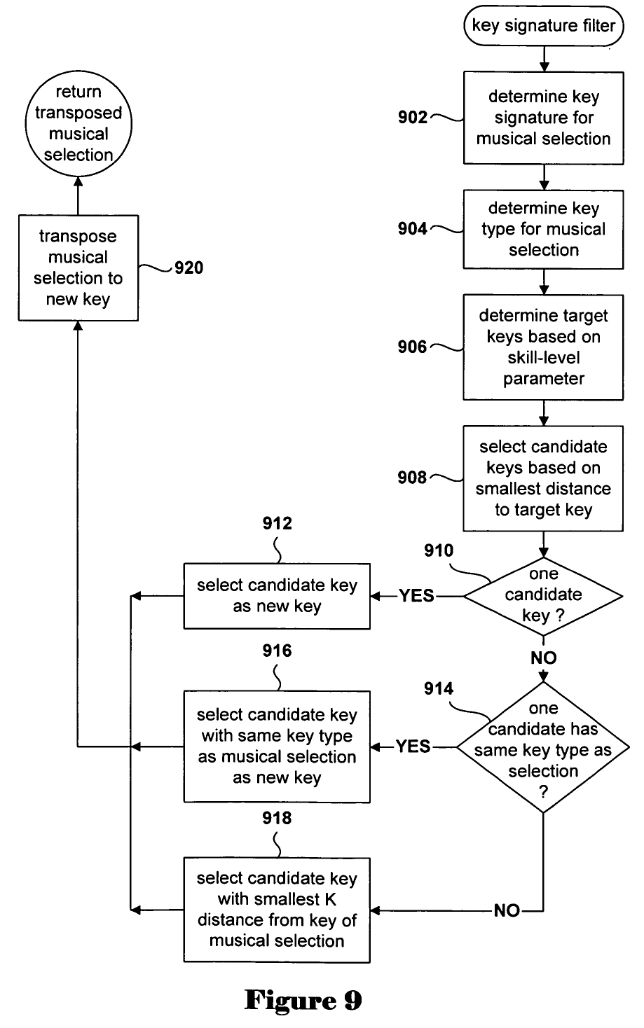

FIG. 9 is a control-flow diagram for the routine “key signature filter” by which key-signature filtering is carried out in one embodiment of the present invention. In step 902, the routine “key signature filter” determines the key signature for the musical selection. The key signature may be explicitly declared, or may be determined by noting the numbers and positions of sharp or flat signs in the key signature at the beginning of the musical notation for the selected musical piece. Next, in step 904, the routine “key signature filter” determines the key type for the key signature determined in step 902. The key type can be determined by table lookup from the key signature, or can be determined algorithmically by noting the position of the key in the circle-of-fifths representation of key signatures relative to a reference key. Next, in step 906, the routine “key signature filter” determines the set of potential candidate keys, determined by skill-level parameters input by user and stored. In one embodiment of the present invention, input numerical skill-level values are mapped to the five skill-levels shown in Table 6. Next, in step 908, a new set of candidate keys is selected from the set of candidate keys corresponding to the selected skill level by choosing candidate keys from the set of candidate keys having a smallest distance, in half-steps from the original key, with regard to the key-signature order shown on FIG. 7. If, as determined in step 910, only a single candidate key results from the selection of step 908, the single candidate key is selected as a new key, in step 912. Otherwise, if only one of the selected candidate keys in step 908 has the same key type as the original key signature, as determined in step 914, then that candidate key is selected as a new key in step 916. Otherwise, a candidate key is selected from among the candidate keys selected in step 908 based on proximity to the original key in the circle-of-fifths representation of key signatures. Finally, in step 920, the musical selection is transposed from the original key to the new key by raising or lowering each note in the musical selection by the distance, in half-steps, from the original key to the new key.

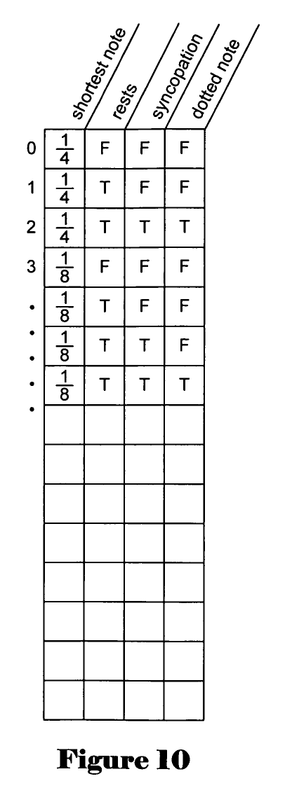

FIG. 10 shows a table of rhythm filters used to alter the musical layers of a musical selection with respect to the rhythm component. Rhythm refers to the timings at, and intervals between which, distinct pitches are produced by depressing fingers, blowing, striking strings or keys, depending on the type of instrument to which the musical selection is directed. Rhythm also refers to the durations for which distinct pitches are held. In musical notation, this information is encoded by a combination of note types, a time signature, and various additional notational conventions, including dotting of notes to lengthen them, ties between notes to coalesce two notes into a single-time-duration event, and general tempo directives. In the table shown in FIG. 10, each row corresponds to a numbered skill level. The described embodiment of the present invention maps specified skill-levels onto the range of skill levels represented by the rows. In the described embodiment, each row includes indications of: (1) the shortest note that can occur in the musical selection for the specified skill level; (2) a Boolean value indicating whether or not rests should be explicitly noted; (3) a Boolean value indicating whether or not syncopation, via note tying, is allowed at the skill level; and (4) a Boolean value indicating whether or not dotted notes are allowed. The system can take many different approaches to filtering a musical selection in order to ensure that the musical selection meets specified rhythm skill levels. For example, notes that are too short in duration can be removed, and adjacent notes extended, or rests inserted, to ensure that only notes having a durations equal to or greater than the specified shortest note for the skill level occur. In alternative embodiments, both the pitch and duration of neighboring notes may be altered in order to smoothly filter short-duration notes. The time signature for the musical selection may also be modified as a part of the filtering process.

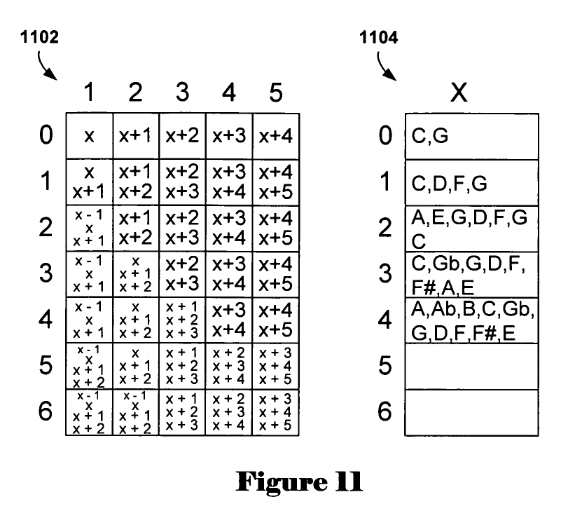

FIG. 11 shows several tables that specify hand and finger position filtering carried out as part of technique filtering. In table 1102, each column corresponds to a finger, each row corresponds to a skill level, and each cell indicates the notes, starting from a specified note “X,” that can be played by a particular finger. Table 1102 thus species potential finger positions, at each of a number of skill levels, for a particular hand position represented by the identity of note “X.” Table 1104 specifies hand positions possible at each of numerous skill levels. In Table 1104, each row corresponds to a skill level, and each cell indicates the different note values for the reference note “X” in table 1102. Tables 1102 and 1104 together specify hand and fingering positions for each skill level. For instruments in which both hands are used for playing, the system maintains a two pairs of tables 1102 and 1104, one pair for each hand. The system can alter a musical selection to correspond to the hand and finger positions appropriate for a selected skill level in many different ways. First, fingering and hand position indications can be introduced into the musical selection that meet the specified skill level, according to the tables, or existing fingering and hand positions can be altered to conform to the specified skill level. Additionally, where necessary, musical notes may be altered or omitted, to avoid requiring hand positions and fingerings not allowed for a particular skill level. Key-signature changes may be used to avoid excessive note alteration or omission. Additional skill-level parameterization may also be used. For example, a skill level may be associated with a maximum number of hand positions, or with a maximum frequency of hand-position changes, or both.

Although the present invention has been described in terms of a particular embodiment, it is not intended that the invention be limited to this embodiment. Modifications within the spirit of the invention will be apparent to those skilled in the art. For example, many other different filters associated with musical components may be used. Pitch range filters may transpose extremely low-frequency or high-frequency notes by octaves in order to bring all notes within a specified maximum pitch range about a reference pitch for a particular instrument. Additional note speed and note density filters may be employed to filter notes with real-time durations shorter than a smallest duration allowed at a specified skill level. When too many notes are specified within any measure for a particular skill level, notes may be eliminated by a note-density filter. Additional technique filters can be employed, including duration of blowing, breath-taking intervals, force of striking or plucking the instrument, etc. The musical-election-variation-generation techniques and systems encompassed by the present invention can be applied in an almost limitless number of different computerized musical systems, implemented in any of many different programming languages on any of many different hardware platforms, using an almost limitless number of different control structures, modular organizations, argument types, variable types and numbers, and other programming parameters and implementation characteristics and styles.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for generating a variation of a musical selection directed to a particular skill level of a performer, the method comprising:
providing one or more skill levels associated with one or more layers and one or more components of the musical selection;
receiving skill-level selections of the one or more layers and one or more components of the musical selection; and
iteratively
for each layer,
for each component,
selecting one or more filters corresponding to the skill level selected for the layer and component; and
applying the filter to the musical selection
until a maximum number of iterations have been carried out or until no changes are made to the musical selection in a most recent iteration.
